(19) United States
(12) Patent Application Publication
(10) Pub. No.: US 2002/0144265 A1
(43) Pub. Date: Oct. 3, 2002

(54) SYSTEM AND METHOD FOR MERGING STREAMING AND STORED CONTENT INFORMATION IN AN ELECTRONIC PROGRAM GUIDE

(76) Inventor: Jay H. Connelly, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/823,400

(22) Filed: Mar. 29, 2001

(51) Int. Cl. H04N 5/445; H04N 7/173

(52) U.S. Cl. 725/39; 725/87

(57) ABSTRACT

A system and method for merging streaming and stored content information in an electronic program guide. The method includes receiving a plurality of streaming content description data about a plurality of streaming content and receiving a plurality of stored content description data about a plurality of stored content. A program guide is then provided, including at least some of the streaming content description data and at least some of the stored content description data. A system implementing the method may comprise a coordinator to receive a plurality of streaming content description data about a plurality of streaming content and a content manager to provide to the coordinator a plurality of stored content description data about a plurality of stored content. The system and method may be implemented in a computing device having a processor and a machine readable medium.

### FIELD OF THE INVENTION

The invention relates generally to electronic program guides and, more specifically, to an electronic program guide that includes information about streaming content and stored content.

### BACKGROUND OF THE INVENTION

Broadcast systems traditionally transmit data to a plurality of client systems such that the data is broadcast at known times. Users of the client systems typically receive the signals from the server system as they are broadcast. In some systems, such as on cable and satellite television systems, an electronic program guide may be broadcast that contains information about programs and when they will be broadcast. Some systems also provide “pay per view” movies. “Pay per view” movies are available from cable or satellite television providers that broadcast the same movies repeatedly on multiple channels at staggered intervals. Users that wish to watch a particular movie simply tune in to one of the channels on which the desired movie is broadcast at a particular known broadcast time.

Users may control when they view broadcast content by recording the content for later viewing a more desirable time. In this way, a user may record a particular program, movie, sporting event, etc. to later view it “on demand” at a time after it was broadcast. Traditionally, this may be achieved by a user setting a video cassette recorder (VCR) to record a desired television program. Recently, digital video recorders paired with digital broadcast services provided by TiVo, Inc. of Alviso, California and Replay TV, Inc. of Mountain View, Calif. have become available. These paired device and service offerings allow for television and movie broadcasts to be recorded on internal hard disk drives rather than the video cassette tapes used by traditional VCRs. The use of digital video recorders is similar to traditional VCRs in that users choose which broadcasts are to be recorded on the internal hard drives by specifying a date and time of a desired program based on an electronic program guide provided by the broadcast system. To view a stored broadcast, the user of a digital video recorder may select from a menu of stored programs in the form of an electronic program guide of locally stored data.

### BRIEF DESCRIPTION OF THE DRAWINGS

FIG. 1 illustrates a hardware environment in which one embodiment of the invention executes.

FIG. 2 illustrates an environment in which one embodiment of the invention executes.

FIG. 3 illustrates a flow of actions taken pursuant to one embodiment of the invention.

### DETAILED DESCRIPTION OF THE INVENTION

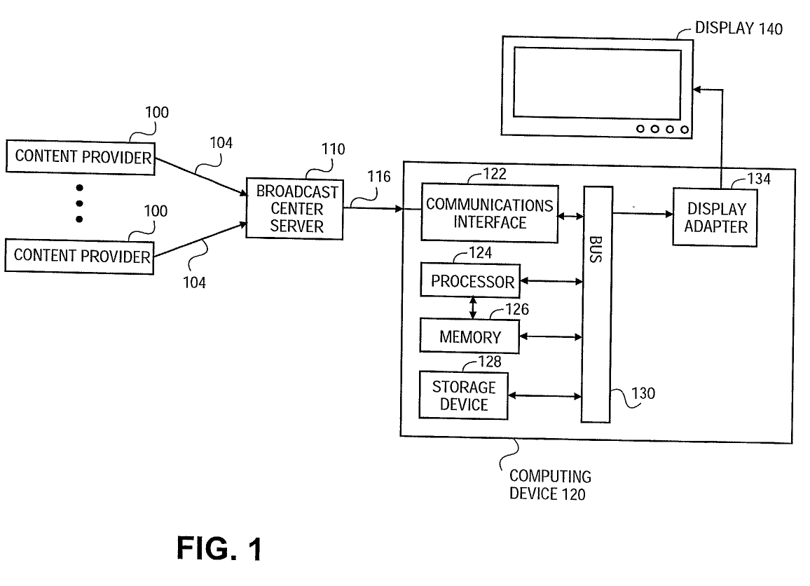

FIG. 1 illustrates an environment in which one embodiment of the invention executes. The invention involves a broadcast center server 110 that receives data from at least one content provider 100 and forwards digital data to at least one client depicted as computing device 120. In one embodiment, broadcast center server 110 may receive content as digital data or analog data. If analog data is received, it is converted into an appropriate digital format before being forwarded to clients. Although only one client, computing device 120, is depicted, the invention involves multiple clients in the form of multiple computing devices. Content provider 100 may be a server computer or a group, subnetwork, local area network (LAN) or other group of multiple computers. The data may be any educational, instructional, informational, or entertainment content in a digital format including, but not limited to, a television program, movie, short, raw data, voice, audio, video, music, graphics, video game, or some combination of these or other similar data. When the content is received from the content providers as analog data, it may be in any well-known or proprietary analog format, such as the National Television System Committee (NTSC) format. The format of the content sent to the clients and received from the content providers may be any digital data format including, for example, data interchange formats such as Internet Protocol (IP) Packets and File Transfer Protocol (FTP) packets; combined audio and moving video formats such as the Digital Video Interface (DVI) format, Indeo® format, formats promulgated by the International Telecommunications Union (ITU), the Advanced Television Systems Committee (ATSC), and similar organizations such as High Definition Television (HDTV), Moving Pictures Expert Group (MPEG) format; related audio formats; still video formats such as Joint Photographic Experts Group (JPEG) format, Graphic Interchange Format (GIF), etc. In one embodiment, the content provider provides the content via connections 104. In one embodiment, connections 104 may be land lines such as T1 lines, T3 lines, coaxial cable, Ethernet, twisted-pair, fiber optic such as a Synchronous Optical Network (SONET), or other any physically present connection capable of delivering high-speed digital data. In another embodiment, the connection may be wireless in the form of microwave, satellite, radio waves, and the like.

Broadcast center server 110 may be a server computer or a group of computers including a subnetwork or a LAN. Broadcast center server 110 distributes digital data to clients, shown as computing device 120, over communication link 116. Communication link 116 may be any means of broadcasting digital data, including, wirelessly via a digital television (DTV) signal, microwave and satellite transmission, and land lines such as digital subscriber line (DSL), T1, T3, SONET, and cable television (CATV).

Clients receive digital data via a computing device such as a set-top box, digital video recorder, digital network recorder, personal computer, portable computer, cellular telephone, personal digital assistant (PDA), computing tablet, or any other similar device. In one-embodiment, computing device 120 includes a communications interface 122 that allows for the receipt of high-speed digital data such as a cable modem, DSL modem, Ethernet interface, satellite receiver, etc. Computing device 120 also includes a non-volatile storage device 128 for storing received digital data for later access. Such storage devices include magnetic media such as hard disk drives and may include other machine readable media such as optical disks, card and stick memory devices, flash memory devices, and the like. In one embodiment, the invention is included in computing device 120 as software that is stored on storage device 128 or other machine readable medium and is executed by processor 124 which utilizes memory 126. Processor 124 may be any processor, and memory 126 may be any kind of random access memory (RAM) or other form of memory.

The computing device processes received digital data and sends a resulting signal via display adapter 134 to a display 140 to be presented to a viewer. Communications interface 122, processor 124, memory 126, storage device 128, and display adapter 134 are, in one embodiment, coupled to bus 130. In various embodiments, computing device 120 may include multiple communications interfaces, processors, storage devices, display adapters, and buses, as well as other components, not shown. In various embodiments, computing device 120 may include an audio processor and/or a game processor or game interface. Although not shown, display 140 may include audio speakers and user input devices such as a remote control, game pad, game controller, joystick, mouse, keyboard, etc. Display 140 may be a cathode ray tube (CRT) display monitor, a thin film transistor (TT) display screen, liquid crystal display (LCD), or any display device suitable for displaying graphics and images.

In one embodiment, information describing the content of digital data that is to be delivered is delivered as program guide data in advance of the actual content that will later be delivered. The description data or program guide data may also be paired with the content when the digital data is delivered. Program guide data may be delivered in various formats, including, but not limited to, the formats specified by the Program and System Information Protocol for Terrestrial Broadcast and Cable (PSIP) of the ATSC, revision A and the Specification for Service Information in DVB Systems (SI) of the European Telecommunications Standards Institute (ETSI) of the European Broadcasting Union (EBU) version 1.4.1.

In one embodiment, the client is a computing device in the form of a smart set-top box and/or digital video recorder through which a user effectively places an order for particular content to be delivered to the user based on information provided in an electronic program guide displayed by the computing device. That is, in one embodiment, the software on the computing device displays program guide information to the user who may then select what programs to currently watch or record for later viewing. In addition, the software on the computing device also allows a user to select digital data already stored on the computing device to be presented to the user. To accomplish this, the software on the computing device may display stored content information, which may be the same as or similar to program guide information, that describes pertinent information concerning the stored digital data.

Examples of program guide information and stored content information include the following. If a movie or television program, the information may include the title, episode name, stars, a brief synopsis, original air date, director, etc. If music only, the information may include the artist, names of songs. If a sporting event, the information may include the names of the teams, the kind of sport, the date of the event, the major players/participants, the coaches, etc. These are just a few examples.

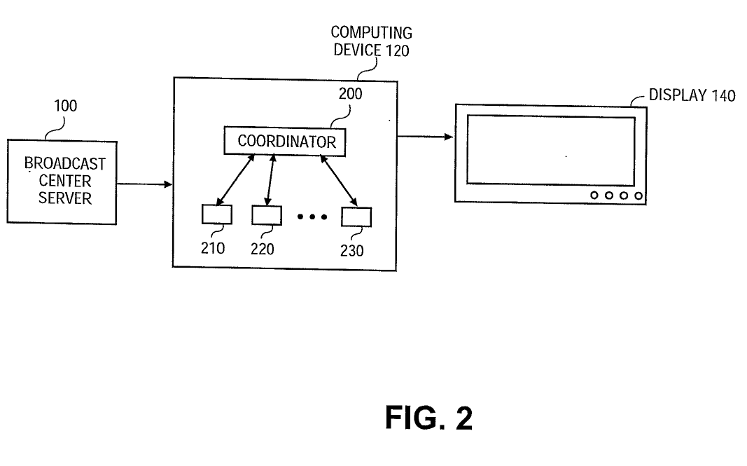

FIG. 2 illustrates an environment in which one embodiment of the invention executes. The software to achieve the method for merging streaming and stored content information in an electronic program guide may be provided in personal computing device 120 and may include broadcast coordinator software 200 and a plurality of content managers such as content managers 210, 220 and 230. Although three content managers are depicted, from one to any number of content managers may be included. In one embodiment, there is a content manager for each kind of digital data that may be received by the computing device from the broadcast center server. In one embodiment, each content manager includes a presentation component and may include a decryption and/or a decompression component. In one embodiment, the software to achieve the invention may be delivered by the broadcast center server upon an initial powering up of the computing device. Updates to content managers and additional content managers may be delivered by the broadcast center server at later times when needed. In another embodiment, some or all of the software needed to achieve the invention may be pre-installed in the computing device on an internal storage device, read only memory (ROM), programmable read-only memory (PROM), flash memory device, etc.

In one embodiment, when digital data is to be presented to a user, the content manager is invoked by the coordinator to prepare the content to be presented to the user. In another embodiment, the content manager may be invoked when live, streaming digital data is to be presented and/or when stored digital data is to be retrieved from a local storage device and presented to the user. The preparation of the digital data by the content manager may be as simple as the presentation component of the content manager reading and/or formatting digital data for use, and may be as complex as including the decryption component of the content manager decoding or otherwise decrypting the digital data and the decompression component of the content manager expanding or decompressing the digital data before the presentation component reads and/or formats the digital data for use. That is, in one embodiment, the digital data received from the broadcast center server and retrieved from the local storage device may be encrypted and/or compressed, and the content manager may decrypt and decompress the digital data when the digital data is to be presented to the user. In another embodiment, some or all of the digital data may be broadcast by the broadcast center server pursuant to the High-bandwidth Digital Content Protection (HDCP) scheme promulgated by Intel Corporation of Santa Clara, Calif. such that either the coordinator or particular content managers decrypt the digital data. Any decryption or decompression may be performed, in various embodiments, immediately before presentation to the user, immediately upon receipt by the computing device, and before or after any requested storage of the digital data to the local storage device.

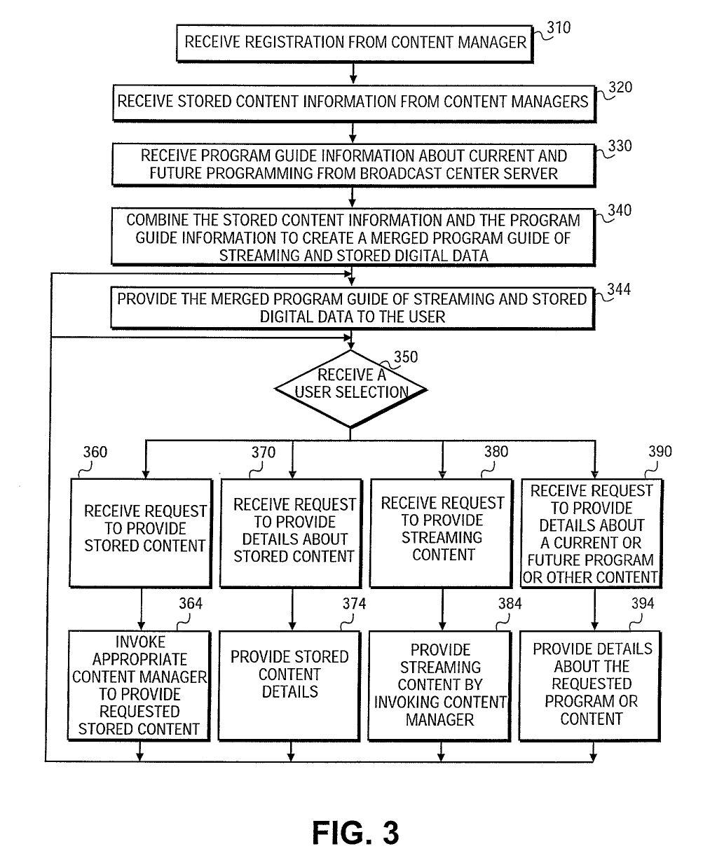

FIG. 3 illustrates a flow of actions taken pursuant to one embodiment of the invention. According to the invention, coordinator software on the computing device receives registration from content managers, as shown in block 310. That is, in one embodiment, each content manager must register with the coordinator, informing it of the digital data with which it is associated. The coordinator may then receive stored content information from the content managers, as shown in block 320. In this embodiment, the content managers provide stored content description information similar to or the same as program guide information to the coordinator. The coordinator then receives program guide information about current and future programming from a broadcast center server, as shown in block 330. This program guide information may be referred to as streaming content description data. The coordinator combines the stored content description information with program guide information received from the broadcast center server to create a merged program guide listing of streaming and stored digital data, as shown in block 340. The coordinator may then provide a program guide including current and future programming information and stored content description information to the user, as shown in block 344. The program guide may be provided to the user, in various embodiments, initially upon powering on the computing device, or upon receiving a request from a user to provide a program guide.

In one embodiment, when the program guide is displayed, a user selection may be received, as shown in block 350. The coordinator may receive a request to provide stored content, as shown in block 360. If so, the coordinator invokes the appropriate content manager to provide the requested stored content to the user, as shown in block 364. Execution may then continue at either block 350 or 344.

The coordinator may receive a request to provide details regarding stored content, as shown in block 370. If so, the coordinator provides the stored content details to the user, as shown in block 374. The stored content details amount to program guide information that may be referred to as stored content description information. In another embodiment, the coordinator may invoke the appropriate content manager to provide the stored content details to the user. Execution may then continue at either block 350 or 344.

The coordinator may receive a request to provide streaming content, as shown in block 380. If so, the coordinator invokes the appropriate content manager to provide the requested streaming content to the user, as shown in block 384. The coordinator may cause the computing device to access the appropriate channel or signal according to any well known techniques. Execution may then continue at either block 350 or 344.

The coordinator may receive a request to provide details about a current or future program or other content, as shown in block 390. If so, the coordinator provides the requested details to the user, as shown in block 394. Execution may then continue at either block 350 or 344. These details amount to program guide information that may be referred to as streaming content description data.

In addition, although not pertinent to the invention, the user may apply commands to streaming or stored content such as fast forward, fast backwards, volume up, volume down, faster, slower, pause, freeze frame, etc., depending on the content.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method comprising:
receiving a plurality of streaming content description data about a plurality of streaming content;
receiving a plurality of stored content description data about a plurality of stored content;
providing a program guide including at least some of the streaming content description data and at least some of the stored content description data.

2. The method of claim 1 further comprising:
receiving a request to present a selected stored content; and
presenting the selected stored content.

3. The method of claim 1 further comprising:
receiving a request to provide a plurality of details about a selected stored content; and
presenting the details about the selected stored content.

4. The method of claim 1 further comprising:
receiving a request to present a selected streaming content; and
presenting the selected streaming content.

5. The method of claim 1 further comprising:
receiving a request to provide a plurality of details about a selected streaming content; and
presenting the details about the selected streaming content.

6. The method of claim 2 wherein presenting comprises:
decrypting the stored content.

7. The method of claim 2 wherein presenting comprises:
decompressing the stored content.

8. The method of claim 4 wherein presenting comprises:
decrypting the streaming content.

9. The method of claim 4 wherein presenting comprises:
decompressing the streaming content.

10. The method of claim 1 further comprising:
receiving a content manager update.

11. The method of claim 1 further comprising:
receiving a new content manager.

12. A system comprising:
a coordinator to receive a plurality of streaming content description data about a plurality of streaming content;
at least one content manager to provide to the coordinator a plurality of stored content description data about a plurality of stored content.

13. The system of claim 12 wherein the coordinator provides a program guide based on the streaming content description data and the stored content description data.

14. The system of claim 12 wherein the coordinator invokes the content manager to present a user selected content.

15. The system of claim 14 wherein the user selected content is one of the plurality of streaming content or one of the plurality of stored content.

16. The system of claim 12 wherein the coordinator comprises:
a presentation component;
a decryption component; and
a decompression component.

17. The system of claim 12 wherein each content manager comprises:
a presentation component;
a decryption component; and
a decompression component.

18. The system of claim 12 wherein the coordinator receives a new content manager.

19. The system of claim 12 wherein the coordinator receives a content manager update.

20. A computing device comprising a machine readable medium and a processor, the machine readable medium including instructions which when executed by the processor cause the processor to perform operations comprising:
receiving a plurality of streaming content description data about a plurality of streaming content;
receiving a plurality of stored content description data about a plurality of stored content;
providing a program guide including at least some of the streaming content description data and at least some of the stored content description data.

21. The computing device of claim 20 wherein the instructions cause the processor to perform further operations comprising:
receiving a request to present a selected stored content; and
presenting the selected stored content.

22. The computing device of claim 20 wherein the instructions cause the processor to perform further operations comprising:
receiving a request to provide a plurality of details about a selected stored content; and
presenting the details about the selected stored content.

23. The computing device of claim 20 wherein the instructions cause the processor to perform further operations comprising:
receiving a request to present a selected streaming content; and
presenting the selected streaming content.

24. The computing device of claim 20 wherein the instructions cause the processor to perform further operations comprising:
receiving a request to provide a plurality of details about a selected streaming content; and
presenting the details about the selected streaming content.
